(19) United States
(12) Patent Application Publication
(10) Pub. No.: US 2024/0152837 A1
(43) Pub. Date: May 9, 2024

(54) UNIFIED COMPUTING PLATFORM

(71) Applicant: STATE STREET BANK AND TRUST COMPANY, Boston, MA (US)

(72) Inventors: Susan ROUSSEAU, Boston, MA (US); Cindy NICASTRO, Boston, MA (US); Erik BALUNIS, Boston, MA (US); Holly MCAVEY, Boston, MA (US); Kristyn HARMON, Boston, MA (US); Cheng LIN, Boston, MA (US); Rich MALING, Boston, MA (US); Bhushan KULKARNI, Boston, MA (US)

(21) Appl. No.: 17/982,062

(22) Filed: Nov. 7, 2022

(51) Int. Cl. G06Q 10/06; G06Q 10/10; G06Q 30/00; G06Q 40/04

(52) U.S. Cl. CPC G06Q 10/06316; G06Q 10/103; G06Q 30/01; G06Q 40/04

(57) ABSTRACT

Exemplary embodiments may provide a unified computing platform for multiple units of an organization that may interface with different clients, management and other stakeholders. The computing platform may include a unifying layer that provides personalization of access to computing resources across business areas and enables access to legacy computing resources. A unified experience is provided for the clients, management and stakeholders by the unifying layer. Common reusable code may be used across organizational units via the unifying layer. Exemplary embodiments may provide an onboarding software tool that improves onboarding of clients to a business organization, including interfacing with the unified computing platform. Exemplary embodiments may provide intelligent handling of trade or transaction exceptions in the unified computing platform across business lines.

### BACKGROUND

Large organizations typically are not monolithic in structure. For example, commonly large business organization have separate business units that perform different functions. For example, a business organization may have an accounting business unit, a human resources business unit, a sales business unit, etc. Often, each business unit may have systems and tools to support the functions of the unit. This may occur independently of other business units in the organization. Hence, separate software, databases and hardware may be provided for each business unit.

In such business organizations, different business units may have similar needs or may need to access to similar resources. Additionally, some client requirements may require users at the business organizations to access systems and tools from multiple business units to obtain the required resources. Further, some systems or tools may be duplicated in multiple business units. This can often make the task of obtaining the resources necessary for performance of a specific business function cumbersome and inefficient for a user, as the user may be required to access multiple systems or tools multiple places to obtain the support necessary for specific functions. This requires knowledge on the part of the user not only of the specific place or places where the required resources may be found but also requires knowledge of the operation of the systems and tools required to obtain the resources necessary for performing the specific business function.

It also may be desirable, from time to time, to replace or compliment legacy systems or tools (e.g., software or databases) with systems or tools that are better performing, provide more functionality, are accessible organization wide, or eliminate duplicative efforts. However, replacement of legacy systems and tools is often expensive, time consuming and disruptive to the operation of the organization. In addition, replacement of legacy tools requires a steep learning curve for users.

### SUMMARY

In accordance with an inventive facet, a computing system includes one or more non-transitory computer-readable storage media storing computer programming instructions and data. The computing system also includes one or more processors configured for executing the computer programming instructions to cause the processor to provide a unifying layer that provides common functionality across units of an organization, personalize access to the common functionality for users, and perform one or more workflows for respective units of the organization.

The personalizing of access may entail, for a selected one of the users, personalizing a user interface that enables the selected user to gain access to computing resources of the computing system. The personalizing of access may include determining the selected computing resources that the selected user is allowed to access and personalizing the user interface so that the selected user may only access the selected computing resources. The organization may be a business organization, and the units may be business units. Each workflow may include computer programming instructions for specifying a sequence of operations to be performed in a process. The computing system may include computer programming instructions that are legacy computer programming instructions for a particular unit of the organization. At least one of the workflows may include an application program interface (API) call to some of the legacy computer programming instructions.

In accordance with another inventive aspect, a computing system includes one or more non-transitory computer-readable storage media storing computer programming instructions. The computing system also includes one or more processors configured for executing the computer programming instructions to cause the processor to identify a trade exception for a trade that was attempted on an electronic trading system, to, based on the identified trade exception, determine a party that should be informed to attempt to resolve the trade exception, and to send an electronic communication to the determined party informing the determined party of the trade exception.

The sending of the electronic communication may include causing an indication of a trade exception to appear on a user interface of the determined party. The electronic communication may be one of a electronic mail message, a short message service (SMS) message, or a message from an electronic messaging service. The determined party may be an operations analyst for analyzing the trade exception. The determined party may be a middle office or an oversight team. The determining of the party that should be informed to attempt to resolve the exception may be based on at least one of a size of the trade, an identity of a party of the trade, or a nature of the trade exception. The computer programming instructions may include computer programming instructions for displaying a user interface on a display for the determined party to process the trade exception.

In accordance with an additional inventive facet, a computing system includes one or more non-transitory computer-readable storage media storing computer programming instructions for an onboarding software tool. The computing system also includes one or more processors configured for executing the computer programming instructions to cause the processor to use the onboarding software tool to gather pre-sale information regarding a potential customer, use the onboarding software tool to store contracts relating to onboarding, and use the onboarding software tool to complete a sale with the potential customer.

The computer programming instructions may include computer programming instructions that cause the processor to provide an ability to electronically sign the contracts. The computer programming instructions may include computer programming instructions that cause the processor to transfer data regarding the potential customer in a customer relationship tool or a pre-sale engagement tool to the onboarding software tool. The transfer of the data regarding the potential customer may be programmatically triggered by an indication of a sale being entered into the onboarding software tool. The computer programming instructions may include computer programming instructions that cause the processor to prompt entry of standard settlement instructions. The computer programming instructions may include computer programming instructions that cause the processor to create a portal for interfacing with the potential customer.

### BRIEF DESCRIPTION OF THE DRAWINGS

FIG. 1 depicts a block diagram of an illustrative unified computing platform architecture for exemplary embodiments.

FIG. 2 illustrates an example of a unifying layer of the unified computing platform where the organization is a financial services business.

FIG. 3 depicts a flowchart of illustrative steps that may be performed in exemplary embodiments in personalizing the view for a user with the unifying layer.

FIG. 4 depicts an illustrative user interface that may be generated by the metrics and risk module to monitor metrics and view the status of investigations of trade issues in exemplary embodiments.

FIG. 5 depicts an illustrative alerts center user interface for exemplary embodiments.

FIG. 6 depicts a flowchart of illustrative steps that may be performed in exemplary embodiments to provide trade exception handling.

FIG. 7 depicts an illustrative user interface that may be generated in exemplary embodiments to show trade exceptions to an operations analyst by module.

FIG. 8 depicts an illustrative user interface of exemplary embodiments that lists trade exceptions being handled by an operations analyst.

FIG. 9 depicts a flowchart of illustrative steps that may be performed in exemplary embodiments as part of the onboarding with the onboarding tool.

FIG. 10 depicts a flowchart of illustrative steps that may be performed in exemplary embodiments to gather information needed for onboarding.

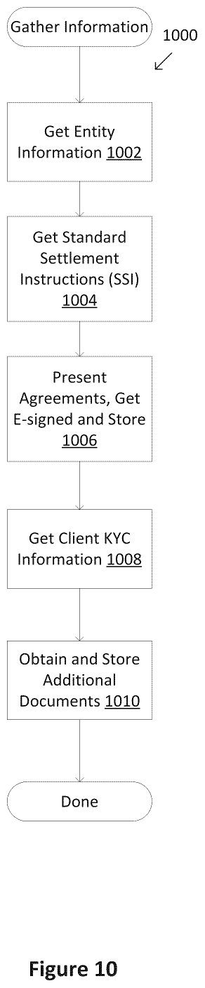

FIG. 11 depicts a flowchart of illustrative steps that may be performed in exemplary embodiments to import data into the onboarding tool from another software tool.

FIG. 12 depicts an initial display screen that may be displayed by the onboarding tool.

FIG. 13 depicts an illustrative user interface that may be shown to gather entity information as part of the onboarding process.

FIG. 14 depicts a computing environment suitable for practicing exemplary embodiments.

FIG. 15 depicts a suitable architecture for computing devices used in exemplary embodiments.

### DETAILED DESCRIPTION

Exemplary embodiments may provide a unified computing platform for multiple units of an organization that may interface with different clients, management and other stakeholders. The computing platform may include a unifying layer that provides personalization of access to computing resources across business areas and enables access to legacy computing resources. A unified experience is provided for the clients, management and stakeholders by the unifying layer. Common reusable code may be used across organizational units via the unifying layer.

Exemplary embodiments described herein may be described with reference to the illustrative case of a specific type of business organization, namely a financial services organization, such as an investment holding company or bank. However, as would be realized by one of skill in the art, the invention is applicable to other types of organizations, including, for example, other types of business organizations, medical organizations, government organizations, military organizations, or the like.

Exemplary embodiments may provide an onboarding software tool that improves onboarding of clients to a business organization, including the interfacing of the client with the unified computing platform. The onboarding tool may be of assistance from pre-sale to the opening of an account with a business organization. Thus, the onboarding tool may provide “cradle to grave” assistance for onboarding clients. The onboarding tool may provide for gathering and storage of critical account documents, such as contracts and the like. The onboarding tool may facilitate electronic signing of contracts.

Exemplary embodiments may provide intelligent handling of trade exceptions in the unified computing platform across business lines. The unified computing platform may include logic for identifying trade exceptions, such as in the unifying layer. The unified computing platform may include logic for generating notifications of trade exceptions. For instance, the unified computing platform may include an exception hub that provides tools for viewing and managing the trade exceptions. The unified computing platform may include logic for intelligent escalation of notices of exceptions for investigation by suitable parties in the hierarchy of the business organization. Some exceptions need to be escalated to higher level parties in the organization other than an operations analyst.

The unified computing platform of exemplary embodiments may allow the user to interact with the available resources of a business organization. The unified computing platform may provide a user interface for the user which is personalized on a user-by-user and function-by-function basis. The user interface may be part of a common portal used across business lines and may be customized by users, including both business employees and clients. The unified computing platform may eliminate the need for the user to have knowledge of specific underlying systems or tools necessary to obtain the required resources for performance of the specific business functions.

At the topmost level, the unified computing platform provides a personalized user interface that enables the user to access specific resources necessary for the performance of specific business functions. At a middle level, the unified computing platform may include rules-based functional modules that obtain required resources and provide the obtained resources to the user at the top level. The functional modules may include knowledge of where and how to obtain the required resources necessary for specific business functions, thereby eliminating the need to the user to have this knowledge at the top level. Legacy systems and tools of the organization may reside at the bottom level of the platform and may be accessed on behalf of the user by the functional modules at the middle level.

The unified computing platform may tailor the resources provided to the user based on the specific needs of the user. The platform may eliminate the need for the user to have knowledge of (1) where the required resources are located; and (2) how to interface with the required system and tools necessary to obtain the required resources.

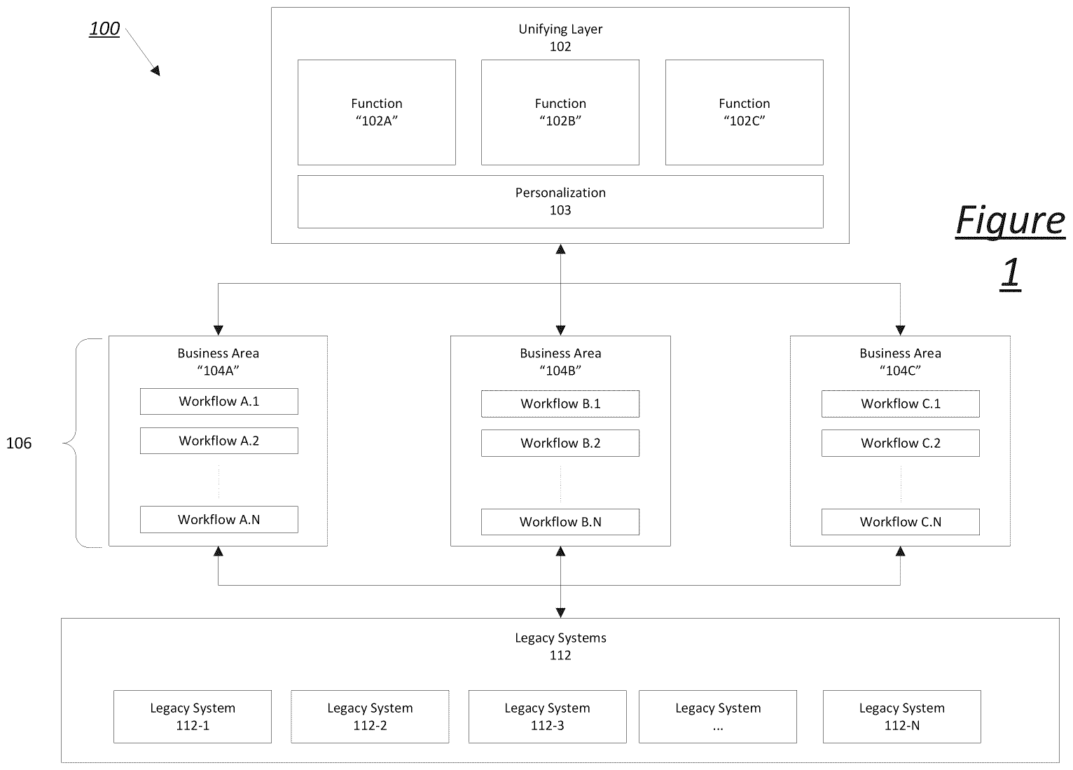

FIG. 1 depicts a block diagram of an illustrative unified computing platform architecture 100 for exemplary embodiments. Legacy systems 112 reside at the lowest level of architecture 100 and may comprise a plurality of legacy systems 112-1, 112-2 . . . 112-N. The legacy systems 112 may provide various types of functions or may include stores of data. The legacy systems 112 may be originally developed for a particular unit of the organization and not for sharing across units. Legacy systems 112 may be automated systems providing specific functions particular to the business organization or may be, for example, databases storing data necessary for the operation of the business organization. In an exemplary embodiment wherein the business organization is an investment holding company or bank, the legacy systems 112 may include, for example, databases containing client information, or databases containing client transactions.

Absent the unifying platform architecture 100, users would be required to directly access legacy systems 112 to perform the required business tasks. Legacy systems 112 may reside on or be executed by one or more servers, which may be, for example, application servers, data servers or combination of application and data servers. The higher layers of architecture 100 shown in FIG. 1 may access services and/or data from legacy systems 112 via a plurality of application programming interfaces (APIs).

The middle layer of the architecture 100 shown in FIG. 1 comprises a plurality of reusable functional modules 106 built on a software development platform. The reusable functional modules 106 may be, for example, workflows (see e.g., Workflows A1-AN, Workflows B1-BN and Workflows C1-CN) providing transactional services and core business logic which access the legacy systems 112 via a plurality of APIs. Each workflow may include computer programming instructions for specifying a sequence of operations to be performed in a process. The functional modules 106 may be rule-based and may provide specific information or perform specific tasks necessary to accomplish specific business functions, based on the rules. In some embodiments, the functional modules 106 may be divided up logically into various business areas 104A, 104B, 104C, each having functional modules providing transactional services and core business logic specific to the individual business area. Functional modules 106 may, in some instances, comprise bots which may work independently to access legacy systems 112 and perform functions, for example, data hygiene, data mining or data gathering for other functional modules. The software development platform on which the reusable function modules are developed may provide a no code/low code environment to streamline the development of new modules. The reusable functional modules may execute on the same application servers or data servers as legacy systems 112 or may execute on different systems which are in communication with the one or more servers executing the legacy systems 112 via networked connections.

The data necessary for performing any of the required business functions of the functional modules may be obtained from or stored into one or more legacy systems 112 by the functional modules via APIs.

At the top layer of architecture 100, unifying layer 102 provides a personalized view for each user, depending upon the user's identity and/or job title. Unifying layer 102 may operate on a remote device and be in communication with lower layer 106 of architecture 100 via a network connection. In some exemplary embodiments, the user, at unifying layer 102 is isolated from legacy systems 112 and only has access to the services and information provided by legacy systems 112 via interaction with the reusable functional modules at levels at 106.

Personalization module 103 may provide a personalized view for each user based on the user's identity and/or the user's job function within the organization. The view may be implemented as a customized user interface. The personalized view may select for access by the user one or more of the functional modules at layer 106. The personalized views may not be limited to internal users and are also designed to unify the experiences and data views for clients and external customers.

Personalization module 103 may be configured manually or may be created by a machine learning model through interaction with the user. That is, the machine learning model may learn which functions are most commonly performed by the user and may customize the user's view via personalization module 103. Additionally, personalization module 103 may provide a basic set of personalized views for users having specific job titles.

The personalized view for each user may include the ability to perform multiple functions, for example, function 102A, 102B, 102C which are necessary for the user to perform as part of the defined job of the user. As is often the case, a required business function 102A, 102B, 102C performed by a user at unifying layer 102 may require access to functional modules from more than one business area 104A, 104B, 104C. In some embodiments, access to the reusable functional modules may be via an API specific to one or a group of functional modules.

In preferred embodiments of the invention, unifying layer 102 may execute on a remote device which may access one or more servers executing reusable functional modules at level 106 via a network connection. The remote device may be any type of computing device including, for example, laptop computers, desktop computers, tablet computing devices, smart phones, etc.

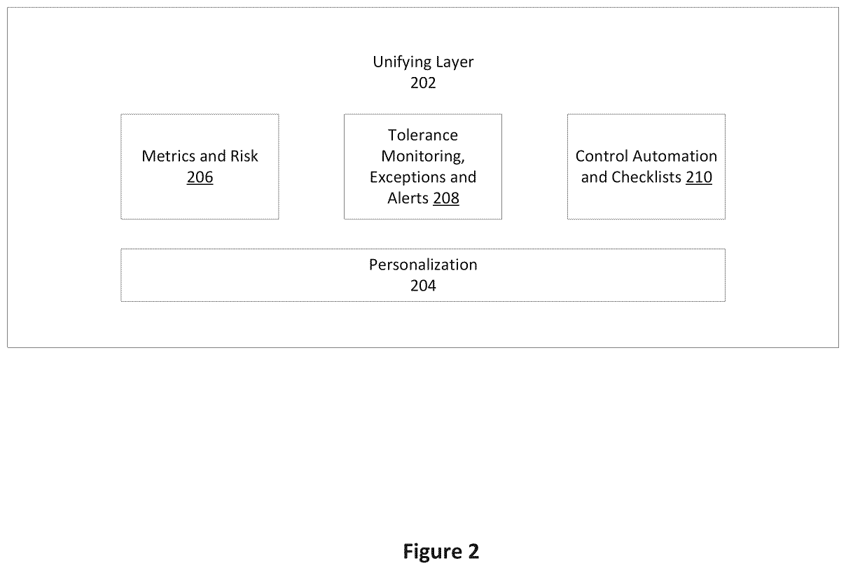

FIG. 2 illustrates an example of a unifying layer 202 of the unified computing platform where the organization is a financial services business, like a bank or an investment holding company, which engages in trading of stocks, bonds, commodities, foreign exchange contracts, derivative contracts or the like. The unifying layer 202 may contain functionality that may be applied across business lines and may include common operations management functionality. For example, the unifying layer 202 may include modules containing computer programming instructions and data for displaying monitored metrics and managing risk 206, modules providing tolerance monitoring, trade exception handling and generating alerts 208, and modules providing control automation and checklists 210. These modules 206, 208 and 210 include common functionality that may be used across business units. These modules 206, 208 and 210 are described in more detail below. Further, the unifying layer 202 may include personalization module 204 for providing a personalized view for each user.

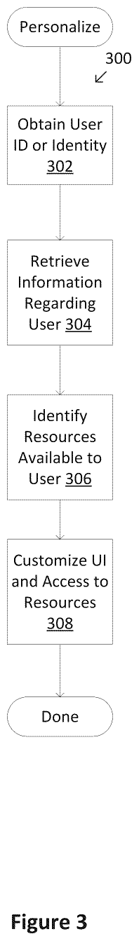

FIG. 3 depicts a flowchart 300 of illustrative steps that may be performed in exemplary embodiments in personalizing the view for a user with the unifying layer 202. At 302, the user ID or identity if the user may be obtained. The user ID may be a user name, email address or the like. The identity may be specified by a name or employee number, for example. At 304, a record for the user may then be retrieved from a database or other source based on the user ID or identity. Where the user is an employee of the business organization, information, such as the job title of the user and the business unit of the user, may be retrieved. Where the user is a client, the retrieved information may specify what services has the client contracted to receive and what business units has the client contracted with. At 306, based on the retrieved information, the resources available to the user may be determined. For example, a senior vice president may have access to different resources than a bookkeeper and the access rights (such as read only access versus write access) may vary. At 308, the user interface available to the user and the resources accessible by the user may be customized to reflect the determination of available resources.

In some exemplary embodiments, such as where the organization is a financial services business, the metrics and risk module 206 in the unifying layer 202 may provide tools for monitoring key metrics and for facilitating risk management across business line. The unifying layer 202 may include common functionality that is applicable across business lines for monitoring key metrics and facilitating risk management. The user interface that displays the metrics and enables risk management by the unified computing platform may be personalized to the user as described above.

When there is an exception with a trade or other transaction executed by the financial services business organization, protocol may dictate that an operations analyst reviews the issue and either resolves the issue or escalates the investigation of the trade exception on to another party who is higher in the internal hierarchy for analysis. For example, a trade exception may need to be reviewed by a middle office or even by a higher level oversight team in some circumstances. The reasons for such escalation may vary but may depend upon the size of the transaction, what parties are involved in a transaction, the nature of the trade exception, etc. As an example, an issue with a large trade like a $100 million trade may require review by a person at a highest level of an internal operations team: the oversight team.

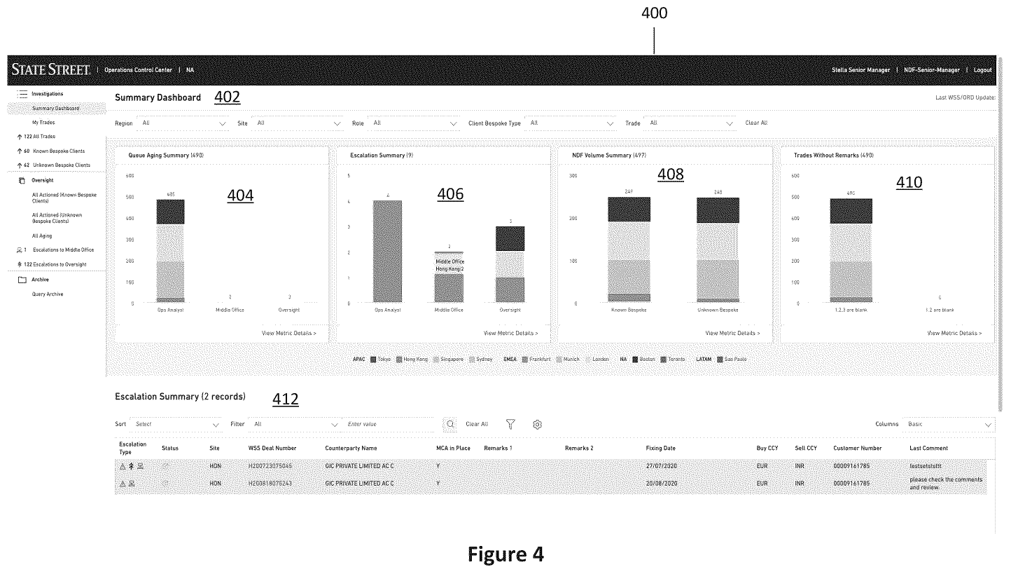

FIG. 4 depicts an illustrative user interface 400 that may be generated by the metrics and risk module 206 to monitor metrics and view the status of investigations of trade issues. This user interface 400 is customized for a senior manager overseeing foreign exchange trades. The user interface 400 includes a summary dashboard 402 that shows a summary of information relating to issues concerning foreign exchange trades. A summary 404 of issues being processed is included. The summary 404 shows a bar chart indicative of issues being handled by operations analysts, the middle office and oversight. In this example, 484 issues are being handled by operations analysts, 2 issues are being handled by the middle office, and 3 issues are being handled by the oversight team. The bars in the bar chart may be color coded to indication of the office handline the investigation.

The summary dashboard 402 also depicts an escalation summary 406 having a bar chart of the number of issues that were escalated by the operation analysts, the middle office and the oversight team. The bars in the escalation summary 406 may be color coded to indicate the identities of the offices that escalated the issues.

A non-deliverable foreign exchange forwards (NDFs) volume summary 408 may be provided with bar charts indicative of how many originated from which office for different categories of clients. NDFs are a variety of foreign exchange contract.

A summary 410 of trades without certain remarks fields completed is provided. A bar chart in the summary 410 includes bars indicative of the number of trades lacking certain subsets of remarks that are color coded by office.

An escalation summary 412 is also provided in the summary dashboard 402. The escalation summary 412 includes a row of information for each escalation. The information may include things like an indication of the type of escalation, the office that escalated, a counterparty name for the trade and comments.

The depicted summary dashboard is particular to the foreign exchange business. Similar summary dashboards may be generated by the unifying layer 202 for other business areas, such as the trading of commodities, bonds or equities.

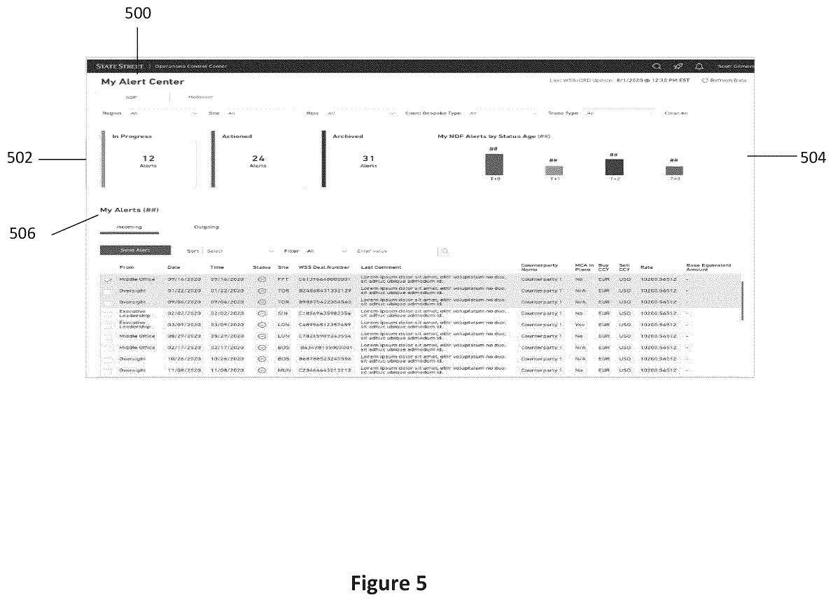

The tolerance monitoring, exceptions and alerts 208 module may generate an alert center user interface 500 like that shown in FIG. 5. The alert center user interface 500 depicts information regarding alerts concerning certain trades or transactions. Alerts are triggered, actions are determined and applied for the alerts if needed, and alerts are archived once they have been addressed. Section 502 of the alert center user interface 500 depicts how many alerts are currently being processed, how many alerts have had actions taken on them and how many alerts have been archived. Section 504 of the alerts center user interface 500 a bar chart of alerts for NDF transactions by age. Lastly, a my alerts section 506 may provide information regarding alerts of interest to the user. Each row contains information regarding a particular alert, such where the alert came from, the date of the alert, the time of the alert, the status of the alert and the like.

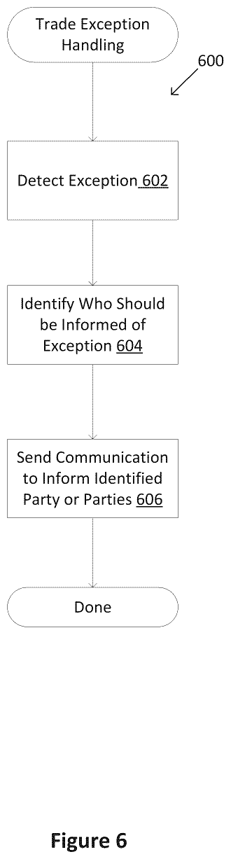

As mentioned above, the unifying layer 202 may provide exception handling for trade exception via module 208. FIG. 6 depicts a flowchart 600 of illustrative steps that may be performed in exemplary embodiments to provide trade exception handling. At 602, a trade exception is detected by logic in module 208. The trades are entered via an electronic trading system that is provided by the unified computing platform. Records of the trade are created when the trade is entered in the electronic trading system. The logic checks to be certain that the trade is correct and that there are no exceptions. If there are exceptions, at 604, module 208 determines who should be informed of the exception. This determination may entail identifying that an operations analyst should be informed, that the middle office should be informed, or that the oversight team should be informed. For example, the logic may look at the amount at stake in the trade. If the amount exceeds $10 million, the middle office should be informed, whereas if the amount exceeds $100 million, the oversight team should be informed. Similarly, the logic may look at the identity of the client involved in the trade. Certain high profile clients may warrant escalation to the middle office or the oversight team when there is a trade exception relating to a trade where they are a party in the trade. Once the party is identified, at 606, a communication is sent to inform the party of the trade exception. The communication may be an email, a phone call, an electronic message, such as an SMS message or a message from an electronic messaging application, or an indication on a user interface.

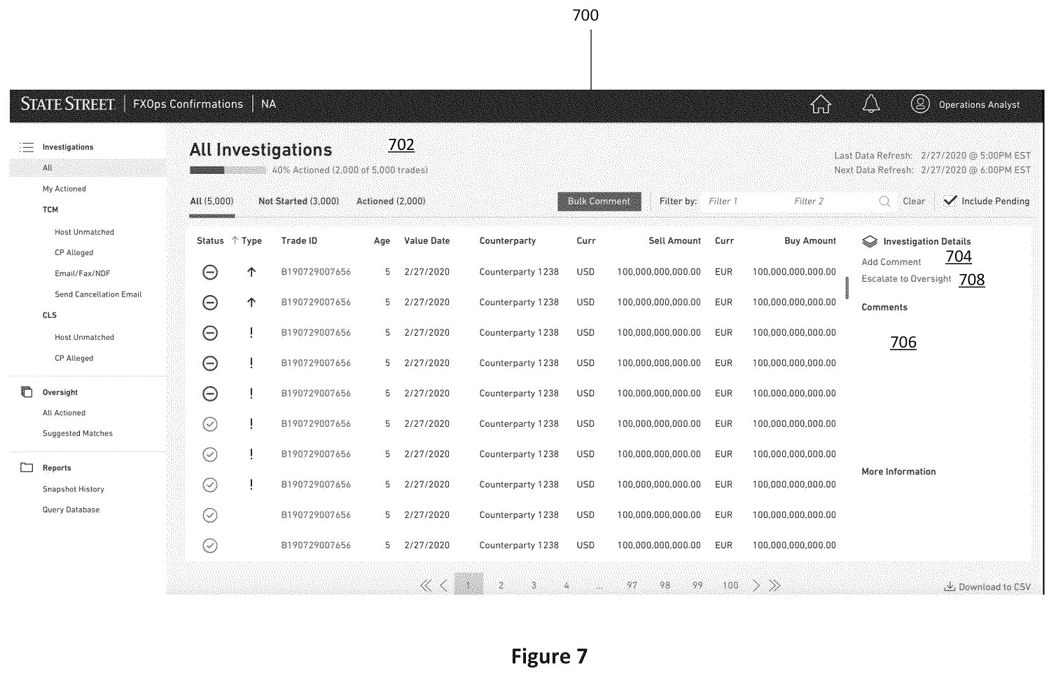

FIG. 7 depicts an illustrative user interface 700 that may be generated in exemplary embodiments to show trade exceptions to an operations analyst by module 207. The user interface 700 displays information about trade exceptions. Specifically, a list 702 of all trade exceptions that are being investigated may be shown. Each row in the list 702 holds information about the associated trade exception, including whether the trade exception has been processed or is waiting to be handle by the operations analyst, and particulars about the trade, The user may select to a particular row and take action relative to the associated trade exceptions. For example, the user may choose option 704 to add a comment that may be entered in comments section 706. Also, the user may select an option 708 to escalate the trade exception to the oversight team for further review.

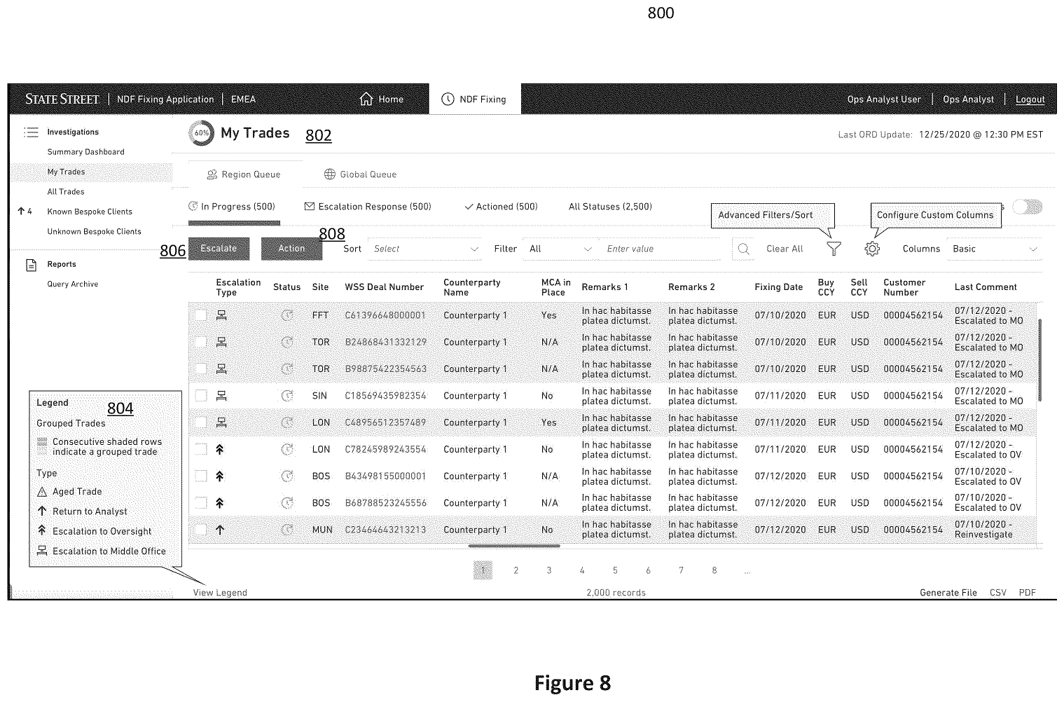

The operations analyst may also display a list of trades that were assigned to the operations analyst. FIG. 8 depicts such as list 802 as part of a user interface 800. The list 802 provides information regarding each trade exception being investigated and includes an icon to indication whether the trade exception has been investigated and what type of escalation has occurred. A legend 804 shows the meaning of the icons. Selection of button 806 causes escalation of a selected investigation, button 808, and selection of button 808 enables the operations analyst to specify an action to be taken regarding the trade exception.

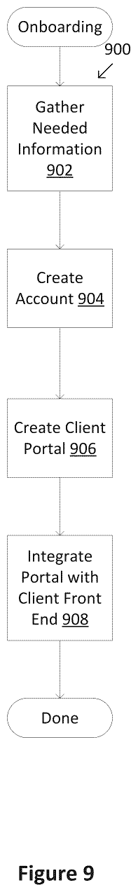

The exemplary embodiments may provide an onboarding tool that provides assistance for onboarding a client of the unified computing platform from pre-sale to opening of an account. FIG. 9 depicts a flowchart 900 of illustrative steps that may be performed in exemplary embodiments as part of the onboarding with the onboarding software tool. Initially, at 902, information needed to create an account is gathered. FIG. depicts a flowchart 1000 of illustrative steps that may be performed in exemplary embodiments to gather the information. First, at 1002, information about the entity (i.e., the client) is gathered. This may include information about the name of the client, address of the client, an organization chart of the client, tax information about the client, credit information for the client and the like. The entity information, in some instances, may be imported from other software tools like customer relationship management (CRM) software or pre-sale engagement software tools, as will be described below. At 1004, standard settlement instructions (SSI) are obtained for the client. The SSI provides banking details for settlement purposes for settlement of trades. The onboarding software tool populates a user interface of information that needs to be gathered to like bank account information. In some embodiments, the user may be able to complete the information via a self-service portal. At 1006, the onboarding tool may present contracts to the client for electronic signature. These may be e-signed by the client, such as via the self-service portal. Examples of agreements include collateral service agreements, customer account agreements, etc. Documents, like fee schedules, may also be presented to the client and saved by the onboarding tool. At 1008, the onboarding tool prompts the gathering of additional “know your client (KYC)” information. KYC is a standard in the investment industry that ensures advisors can verify a client's identity and know their client's investment knowledge and financial profile. At 1010, any additional documents associated with the client account may be obtained and stored.

Referring again to FIG. 9, after the information is gathered at 902, at 904, a client account may be created. Thus, records for a formal account with the business organization are created and service may be started. At 906, a client portal is created to enable the client to access the unified computing platform to gain access to the account that was created. At 908, the client portal is integrated with the front end of the client's IT infrastructure so that the client portal may be accessed by users at the client.

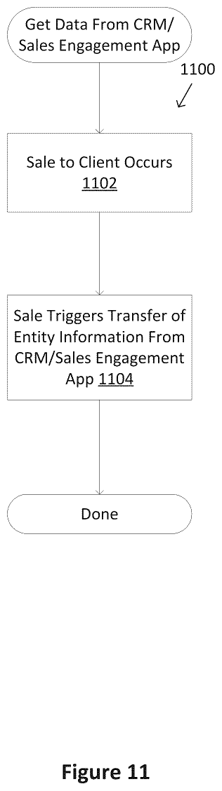

As was mentioned above, data regarding a client may be imported into the onboarding tool from other tools. FIG. 11 depicts a flowchart 1100 of illustrative steps that may be performed in exemplary embodiments to import such data. At 1102, a sale to the client occurs. The onboarding may have an input that is entered once the sale is complete. The input, at 1104, may trigger the transfer of entity information (e.g., client information) from a software tool like a CRM application or pre-sale engagement tool that already contains information previously gathered regarding the client. The transfer populates fields requested by the onboarding tool.

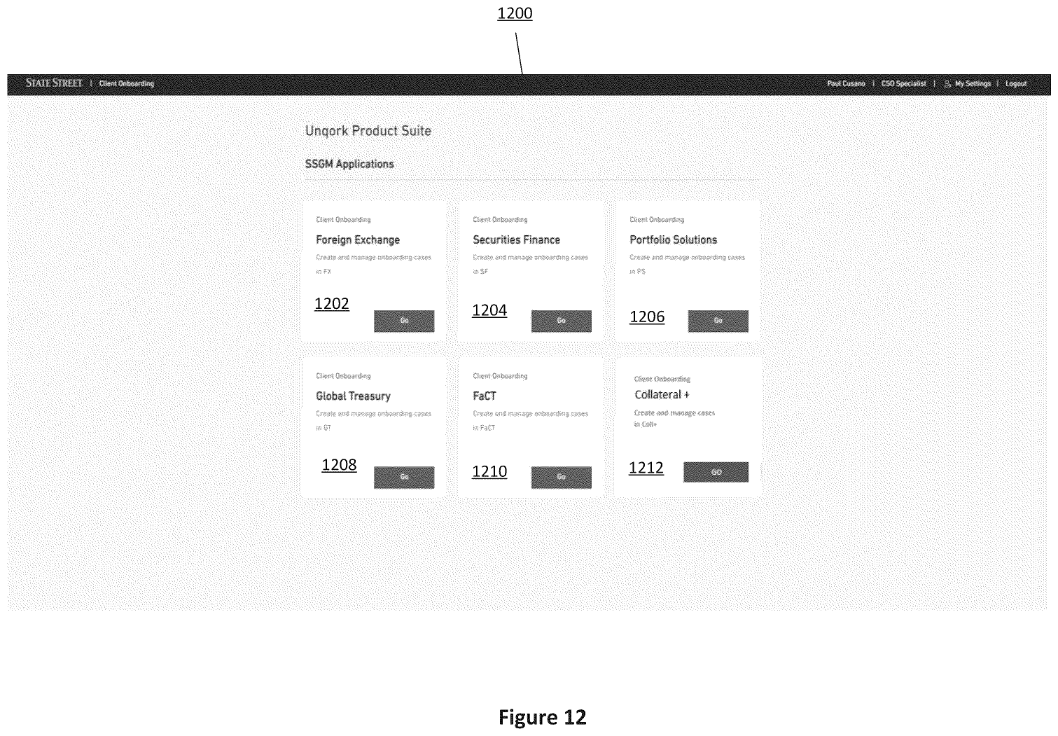

FIG. 12 depicts an initial screen 1200 that may be displayed by the onboarding tool. A number of options are provided for the type of services the client wishes to receive. An option 1202 is for foreign exchange services, an option 1204 is for securities finance services, and an option 1206 is provided for portfolio solutions services. Additional options include option 1208 for global treasury services, option 1210 for funding and collateral transformation services, and option 1212 for collateral management services. Selection of one of these options 1202, 1204, 1206, 1208, 1210 or 1212, will initiate the onboarding process for the selected service option.

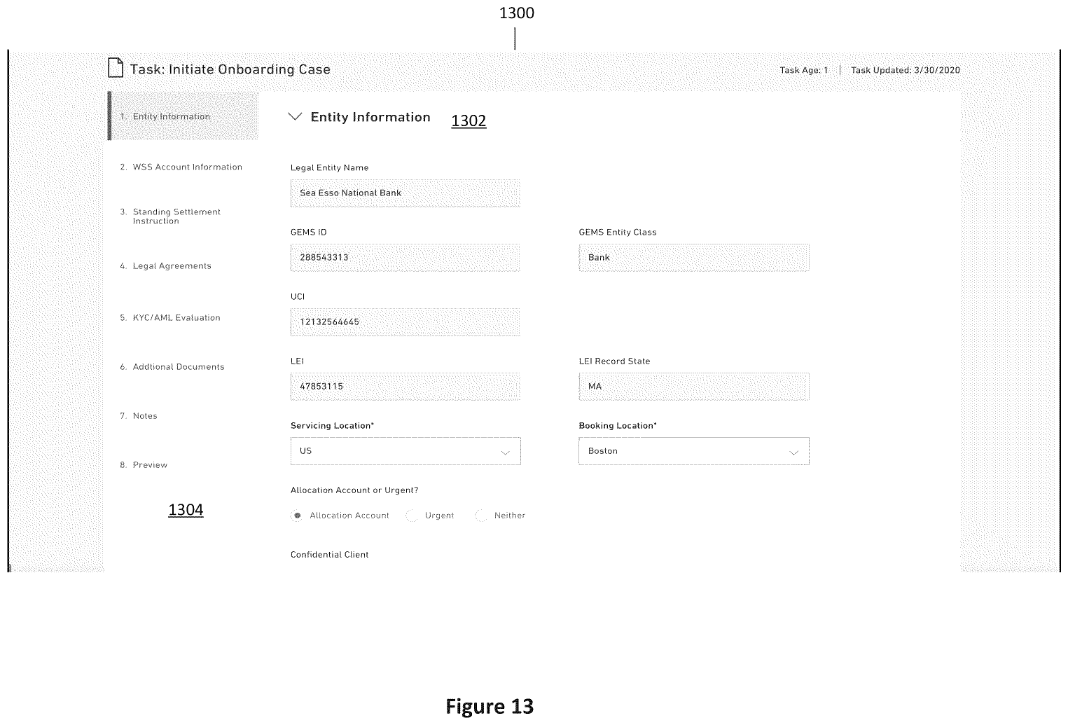

FIG. 13 depicts an illustrative user interface 1300 that is shown to gather entity information as part of the onboarding. Various fields are provided in a right pane 1302 to enter information regarding the client, like name, GEMS ID, GEMS entity class, etc. The left pane 1304 contains a list of other types of information that are needed to create an account, such as WSS account information, SSI information, legal agreements, KYC information, other documents, notes and a client portal preview.

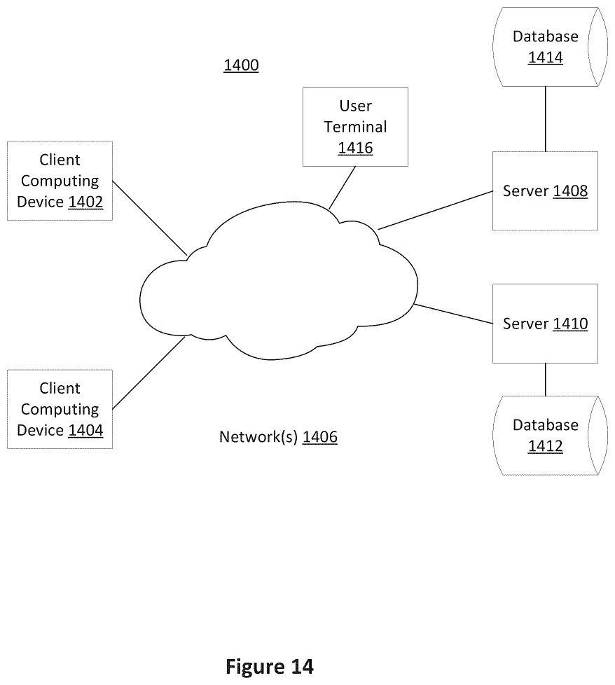

FIG. 14 depicts a computing environment 1400 suitable for practicing exemplary embodiments. Client computing devices 1402 and 1404 are connected to network(s) 1406. The network(s) 1406 may include both wired and wireless networks and may include both local area networks and wide area networks, including the Internet. The client computing devices 1402 and 1404 may be, for example, personal computers, laptop computers, workstations, tablet computers or other types of computing devices. The client computing devices 1402 and 1404 may be used by clients to gain access to the portals, web pages or applications provided by servers 1408 and 1410. The servers 1408 and 1410 may execute computer programming instructions that perform the functionality described above for the unified computing platform. The servers 1408 and 1410 may be server computing devices of the organization or may be part of a cloud or cluster provided by a cloud services provider. The servers 1408 and 1410 have access to respective databases 1414 and 1412. The databases 1408 and 1410 may hold records relational tables and data required for operation of the unified computing platform. The databases 1408 and 1410 may be part of a data lake or other structure for the organization. A user terminal 1416 may be provided for a user of an organization to access the unified computing platform. The user of the user terminal 1416 may be an employee or agent of the organization.

It should be appreciated that the depiction in FIG. 14 is intentionally simplified for clarity. There may be a much larger number of client computing device, user terminals, servers and databases in many embodiments.

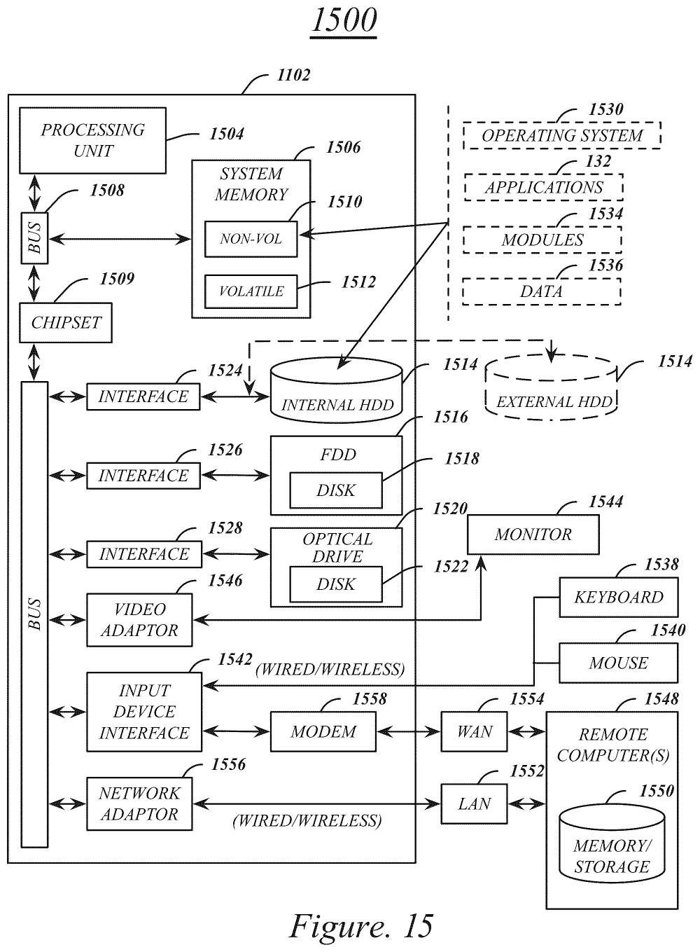

FIG. 15 depicts a suitable architecture for computing devices like the servers 1408, and 1410 shown in FIG. 14. The computing device 1500 includes a processing unit 1504, a system memory 1506 and a system bus 1508. In some embodiments, a system bus 1508 may interconnect the processing unit 1504 with the system memory 1506 and a chipset 1509 may interconnect a system bus 1508 with one or more other buses to interconnect the peripherals (such as interfaces 1524-1528, video adapter 1546, input device interface 1542, and/or network adaptor 1556) with the system bus 1508. In other embodiments, the system memory 1506 may couple with the processing unit 1504 via one or more direct links, the processing unit 1504 may couple with a chipset (not shown) via one or more direct links, and the chipset 1509 may couple with the peripherals through one or more other buses. In some embodiments, the direct links may comprise high-speed serial links.

The processing unit 1504 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 1504. The processing unit 1504 may execute computer programming instructions stores in system memory 1506 to perform the functionality described herein.

The system bus 1508 provides an interface for system components including, but not limited to, the system memory 1506 to the processing unit 1504. The system bus 1508 can be any of several types of bus structure that may further interconnect to a memory bus (with or without a memory controller), a peripheral bus, and a local bus using any of a variety of commercially available bus architectures. Interface adapters may connect to the system bus 1508 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing device architecture 1500 may include or implement various articles of manufacture. An article of manufacture may include a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable storage medium, which may be read and executed by one or more processors to enable performance of the operations described herein.

The system memory 1506 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 15, the system memory 1506 can include non-volatile memory 1510 and/or volatile memory 1512. A basic input/output system (BIOS) can be stored in the non-volatile memory 1510. The system memory 1506 may store the computer programming instructions referenced herein for realizing the described functionality of the unified computing platform.

The computer 1502 may include various types of computer-readable storage media in the form of one or more lower speed memory units, including an internal (or external) hard disk drive (HDD) 1514, a magnetic floppy disk drive (FDD) 1516 to read from or write to a removable magnetic disk 1518, and an optical disk drive 1520 to read from or write to a removable optical disk 1522 (e.g., a CD-ROM, DVD, or Blu-ray). The HDD 1514, FDD 1516 and optical disk drive 1520 can be connected to the system bus 1508 by a HDD interface 1524, an FDD interface 1526 and an optical drive interface 1528, respectively. The HDD interface 1524 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory 1510, 1512, including an operating system 1530, one or more application programs 1532, other program modules 1534 such as those of the unified computing platform, including the unifying layer, the legacy systems and an electronic trading platform, and program data 1536. In some embodiments, the one or more application programs 1532, other program modules 1534, and program data 1536 can include, for example, the various applications and/or components to implement the disclosed embodiments.

A user can enter commands and information into the computer 1502 through one or more wire/wireless input devices, for example, a keyboard 1538 and a pointing device, such as a mouse 1540. Other input devices may include microphones, infra-red (IR) remote controls, radio-frequency (RF) remote controls, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 1504 through an input device interface 1542 that is coupled to the system bus 1508, but can be connected by other interfaces such as a parallel port, IEEE 1394 serial port, a game port, a USB port, an IR interface, and so forth.

A display 1544 is also connected to the system bus 1508 via an interface, such as a video adaptor 1546. The display 1544 may be internal or external to the computer 1502. In addition to the display 1544, a computer typically includes other peripheral output devices, such as speakers, printers, and so forth.

The computer 1502 may operate in a networked environment using logical connections via wire and/or wireless communications to one or more remote computers, such as a remote computer 1548. The remote computer 1548 can be a workstation, a server computer, a router, a personal computer, portable computer, microprocessor-based entertainment appliance, a peer device or other common network node, and typically includes many or all of the elements described relative to the computer 1502, although, for purposes of brevity, only a memory/storage device 1550 is illustrated. The logical connections depicted include wire/wireless connectivity to a local area network (LAN) 1552 and/or larger networks, for example, a wide area network (WAN) 1554. Such LAN and WAN networking environments are commonplace in offices and companies, and facilitate enterprise-wide computer networks, such as intranets, all of which may connect to a global communications network, for example, the Internet.

When used in a LAN networking environment, the computer 1502 is connected to the LAN 1552 through a wire and/or wireless communication network interface or adaptor 1556. The adaptor 1556 can facilitate wire and/or wireless communications to the LAN 1552, which may also include a wireless access point disposed thereon for communicating with the wireless functionality of the adaptor 1556.

When used in a WAN networking environment, the computer 1502 can include a modem 1558, or is connected to a communications server on the WAN 1554, or has other means for establishing communications over the WAN 1554, such as by way of the Internet. The modem 1558, which can be internal or external and a wire and/or wireless device, connects to the system bus 908 via the input device interface 1542. In a networked environment, program modules depicted relative to the computer 1502, or portions thereof, can be stored in the remote memory/storage device 1550. It will be appreciated that the network connections shown are exemplary and other means of establishing a communications link between the computers can be used.

The computer 1502 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

Software related implementations of the systems and methods described herein may include, but are not limited to, firmware, application specific software, or any other type of computer readable instructions that may be executed by one or more processors. The computer-readable instructions may be provided via non-transitory computer-readable media. In some examples, the systems and methods described herein, and/or any constituent component described herein may be implemented with a processor executing computer-readable instructions stored on one or more memory components.

Implementations provided herein should be considered exemplary only and are not meant to limit the invention in any way. As one of skill in the art would realize, many variations on implementations discussed herein which fall within the scope of the invention are possible. Moreover, it is to be understood that the features of the various embodiments described herein are not mutually exclusive and can exist in various combinations and permutations, even if such combinations or permutations were not made express herein, without departing from the spirit and scope of the invention. Accordingly, the system and method disclosed herein are not to be taken as limitations on the invention but as an illustration thereof. The scope of the invention is defined by the claims which follow.

1. A computing system, comprising:
one or more non-transitory computer-readable storage media storing computer programming instructions and data;
one or more processors configured for executing the computer programming instructions to cause the processor to:
provide a unifying layer that provides common functionality across units of an organization;
personalize access to the common functionality for users; and
perform one or more workflows for respective units of the organization.

2. The computing system of claim 1, wherein the personalizing access entails for a selected one of the users personalizing a user interface that enables the selected one of the users to gain access to computing resources of the computing system.

3. The computing system of claim 2, wherein the personalizing access comprises determining the selected computing resources that the selected one of the users is allowed to access and personalizing the user interface so that the selected one of the users user may only access the selected computing resources.

4. The computing system of claim 1, wherein the organization is a business organization and the units are business units.

5. The computing system of claim 1, wherein each workflow comprises computer programming instructions for specifying a sequence of operations to be performed in a process.

6. The computing system of claim 1, wherein the computing system includes computer programming instructions that are legacy computer programming instructions for a particular unit of the organization.

7. The computing system of claim 1, wherein at least one of the workflows includes an application program interface (API) call to some of the legacy computer programming instructions.

8. A computing system, comprising:
one or more non-transitory computer-readable storage media storing computer programming instructions;
one or more processors configured for executing the computer programming instructions to cause the processor to:
identify a trade exception for a trade that was attempted on an electronic trading system;
based on the identified trade exception, determine a party that should be informed to attempt to resolve the trade exception; and
send an electronic communication to the determined party informing the determined party of the trade exception.

9. The computing system of claim 8, wherein the sending an electronic communication comprises causing an indication of a trade exception to appear on a user interface for the determined party.

10. The computing system of claim 9, where in the electronic communication is one of a electronic mail message, a short message service (SMS) message, or a message from an electronic messaging service.

11. The computing system of claim 9, wherein the determined party is an operations analyst for analyzing the trade exception.

12. The computing system of claim 11, wherein the determined party is a middle office or an oversight team.

13. The computing system of claim 9, wherein the determining of the party that should be informed to attempt to resolve the exception is based on at least one of a size of the trade, an identity of a party of the trade or a nature of the trade exception.

14. The computing system of claim 9, wherein the computer programming instructions include computer programming instructions for displaying a user interface on a display for the determined party to process the trade exception.

15. A computing system, comprising:
one or more non-transitory computer-readable storage media storing computer programming instructions for an onboarding software tool;
one or more processors configured for executing the computer programming instructions to cause the processor to:
use the onboarding software tool to gather pre-sale information regarding a potential customer;
use the onboarding software tool to store contracts relating to onboarding; and
use the onboarding software tool to complete a sale with the potential customer.

16. The computing system of claim 15, wherein the computer programming instructions include computer programming instructions that cause the processor to provide an ability to electronically sign the contracts.

17. The computing system of claim 15, wherein the computer programming instructions include computer programming instructions that cause the processor to transfer data regarding the potential customer in a customer relationship tool or a pre-sale engagement tool to the onboarding software tool.

18. The computing system of claim 17, wherein the transfer of the date regarding the potential customer is programmatically triggered by an indication of a sale being entered into the onboarding software tool.

19. The computing system of claim 15, wherein the computer programming instructions include computer programming instructions that cause the processor to prompt entry of standard settlement instructions.

20. The computing system of claim 15, wherein the computer programming instructions include computer programming instructions that cause the processor to create a portal for interfacing with the potential customer.
